(19) United States
(12) Patent Application Publication
(10) Pub. No.: US 2025/0341619 A1
(43) Pub. Date: Nov. 6, 2025

(54) HIGH PHOTON RATE SPAD DEVICE

(71) Applicant: SEMICONDUCTOR COMPONENTS INDUSTRIES, LLC, Scottsdale, AZ (US)

(72) Inventor: Colin BARRY, Cork (IE)

(73) Assignee: SEMICONDUCTOR COMPONENTS INDUSTRIES, LLC, Scottsdale, AZ (US)

(21) Appl. No.: 18/652,203

(22) Filed: May 1, 2024

(51) Int. Cl. G01S 7/4865; G01J 1/44; G01S 17/10; G04F 10/00

(52) U.S. Cl. CPC G01S 7/4865; G01J 1/44; G01S 17/10; G04F 10/005; G01J 2001/442; G01J 2001/4466

(57) ABSTRACT

Systems, devices, and methods are described to determine an intensity of a target in a field of view of an imaging device using a single-photon avalanche diode (SPAD) device. Systems, devices, and processes may receive multiple successive timestamps from a timestamp circuitry of the SPAD device in response to the SPAD device successively detecting photons during a time period, determine an inter-arrival time for each pair of successive timestamps, perform a statistical analysis of the collection of inter-arrival times, and determine an indication of the intensity of the target based on the statistical analysis. The statistical analysis may include determining a mean of the collection of inter-arrival times, and the indication of the intensity may include a reciprocal of the determined mean. The inter-arrival times may be determined by circuitry including a timestamp memory and a subtraction circuit coupled between the timestamp circuitry and a readout processor.

### BACKGROUND

This application relates generally to imaging systems and, more particularly, to imaging systems that use single-photon avalanche diodes (SPADs) for determining light intensity.

Active ranging systems may illuminate a target with light and measure the return time of the light reflected off the target to determine a distance to the target. For example, light detection and ranging (LiDAR) systems may illuminate a target with laser pulses and measure the time-of-flight (ToF) of the laser pulses between the LiDAR system and the target. The LiDAR system may use an array of SPADs to detect the reflected light, and timestamp circuitry such as time-to-digital converters (TDCs) to determine the time interval between a transmitted laser pulse and the reflected pulse received by a SPAD.

LiDAR systems receive both the reflected laser pulses as well as ambient photons, for example solar photons, and each type of photon may be detected by the SPADs. To accurately determine the range of the target, LiDAR systems may calculate a histogram of return times for a number of laser pulses to identify a time bin having the most detections. Each histogram time bin may correspond to a particular distance range. The identified histogram bin may then be interpreted as corresponding to the return time of the laser pulse, from which a target distance may be determined.

LiDAR systems may also measure an intensity value for the target to infer information about the target's reflectivity and/or color, for example due to material type and/or color. A target with a higher intensity will generally reflect more photons than a target with lower intensity. LiDAR systems may determine a light intensity by counting the number of photons received by each SPAD pixel using hardware counters.

A SPAD pixel observing typical outdoor, sunlit conditions may receive about 10⁵ to about 10¹⁰ ambient photons per second, though the actual number of detected photons will be less due to detection efficiency, SPAD dead time, and other system parameters. Even though the number of detected photons will be reduced, typical outdoor ambient conditions will still quickly saturate the hardware counters, leading to a loss of intensity information. The hardware counter bit depth may be increased, for example from 8-bit to 12-bit, to assist with the increased photon rate. However, increasing the hardware counter bit depth quickly leads to a large and undesirable increase in the chip area occupied by the hardware counters.

It would therefore be desirable to provide improved devices and methods for determining an intensity value of a target using SPAD pixels.

### BRIEF DESCRIPTION OF DRAWING FIGURES

FIG. 1 is a schematic diagram showing an exemplary system that includes SPAD-based LiDAR system, according to various embodiments.

FIG. 2 is a circuit diagram showing an exemplary SPAD device, according to various embodiments.

FIG. 3 is a schematic diagram showing a SPAD-based imager, according to various embodiments.

FIG. 4 is a flowchart of an illustrative method of operating a SPAD imager using photon inter-arrival time, according to various embodiments.

FIG. 5 illustrates a simulated photon counter performance for different incident photon rates.

FIG. 6 illustrates a simulated performance of determining intensity based on a photon counting method and an inter-arrival time method, according to various embodiments.

### BRIEF SUMMARY

Various embodiments relate to systems, devices, and methods to automatically determine an intensity of a target using one or more SPAD devices.

In various embodiments, a device for determining an intensity of a target may include one or more single photon avalanche diodes (SPADs), a timestamp circuitry coupled to the one or more SPADs and configured to output a timestamp in response to receiving an avalanche pulse from the one or more SPADs, an inter-arrival time (IAT) circuitry coupled to the timestamp circuitry, wherein the IAT circuitry is configured to determine a time difference between successive photons detected by the one or more SPADs based on successive timestamps received from the timestamp circuitry, and an averaging circuitry coupled with the IAT circuitry, wherein the averaging circuitry is configured to statistically analyze a plurality of determined time differences from the IAT circuitry to determine an indication of the intensity of the target.

In various embodiments, a method of operating a single photon avalanche diode (SPAD) device may include receiving, from a timestamp circuitry of the SPAD device, a plurality of successive timestamps in response to a plurality of successive photons detected by the SPAD device, determining, by an inter-arrival time (IAT) circuitry and based on the plurality of successive timestamps, a plurality of inter-arrival times, wherein each inter-arrival time represents a time difference between photons successively detected by the SPAD device, performing, using an averaging circuitry, a statistical analysis of the plurality of inter-arrival times, and determining an indication of an intensity of a target of the SPAD device based on the statistical analysis.

In various embodiments, a light detection and ranging system may include a laser, a single photon avalanche diode (SPAD) imager configured to, in an intensity mode: measure a plurality of inter-arrival times (IAT), wherein each IAT represents a time difference between successive photons detected by the SPAD imager, perform a statistical analysis of the plurality of IATs, and determine an indicator of an intensity of a target based on the statistical analysis; and an optical device operable to direct a laser pulse from the laser toward the target and to direct one or more photons from the target to the SPAD imager.

These and other examples are described in increasing detail below.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, SPAD-based imaging systems and methods are used to measure the intensity of a target in a sensed environment. As the intensity of a target increases, the amount of photons received from the target may increase and the time between successive detections of the photons may decrease. The SPAD-based imaging system may determine information about the time between successive detections of photons by one or more SPAD devices, which may then be used to determine an indication of intensity.

Various embodiments may determine an inter-arrival time (IAT) for each pair of successive photon detections, may perform a statistical analysis of multiple IATs observed during a time period such as an integration period, and may determine an indication of the intensity based on the statistical analysis. Some embodiments may determine the mean of the observed IATs, and may provide the reciprocal of the mean as the indication of the intensity.

Advantageously, systems and methods according to the present description have improved performance and require less semiconductor chip area to implement. The performance improvement may include a larger dynamic range compared to photon counter-based systems and methods. In addition, the IAT-based indication of intensity may be performed in between laser pulses of a depth sensing mode. The IAT-based indication of intensity may further be converted to a photon count equivalent as desired.

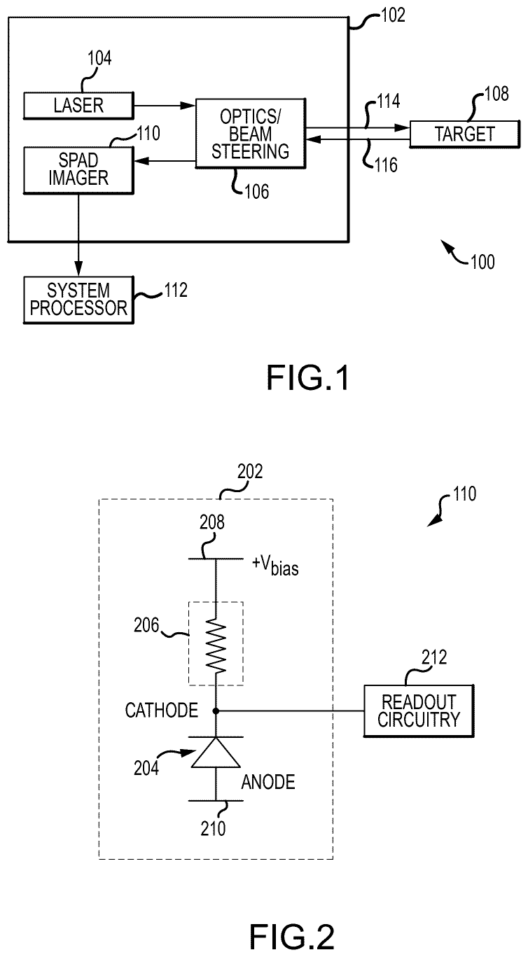

FIG. 1 is a schematic diagram illustrating an exemplary system that includes SPAD-based imaging. System 100 may include a LiDAR imaging system 102, which may be referred to herein as a LiDAR module. In some embodiments, system 100 may be a vehicular LiDAR system, for example for navigation, obstacle avoidance, or other safety functions. System 100 may additionally or alternatively be a surveillance system, machine vision system, survey system, or any other suitable system. LiDAR module 102 may be used to measure distance to one or more targets, which also may be referred to as obstacles. LiDAR module 102 may also or alternatively capture images of a scene or the environment in which the module 102 is present.

The LiDAR module 102 may include a laser 104 that emits light at one or more desired wavelengths. An optics and beam steering module 106 may determine a field of view (FoV) of the LiDAR module 102 and may direct a light beam 114 from the laser 104 toward a target 108 in the FoV. The light beam 114 may be in any suitable configuration, for example a flash illumination, line scan, point scan, or the like, and may be based in part on a configuration of the SPAD-based imager 110, optics and beam steering module 106, or the like.

The light may reflect 116 off the target 108 and return to the LiDAR module 102. One or more lenses and/or other optical equipment in the optics and beam steering module 106 may focus the reflected light 116 and/or other ambient light in the FoV onto a SPAD-based imager 110. Each SPAD of the SPAD-based imager 110 may collect photons from the FoV. In some embodiments, the SPAD-based imager 110 may include one or more microlenses to further direct the received reflected light 116 into one or more SPADs of the SPAD-based imager 110.

The SPAD-based imager 110, also referred to herein as a SPAD imager 110, may be a sensor device having one or more single-photon avalanche diode (SPAD) devices for detecting an incident photon. In some embodiments, the SPAD imager 110 may be a silicon photomultiplier device (SiPM) having a plurality of SPAD devices. A SPAD may comprise a semiconductor diode and may be configured to receive incident photons. The LiDAR module 102 may, for example from the SPAD imager 110 directly, output information about the detected photons, and in some cases may output information regarding the aiming of the light beam 114 by the optics and beam steering module 106 for which the photons were detected. In some embodiments, the LiDAR module 102 may output this information to a higher-level processor 112 of the system 100, for example to a processor of a vehicular LiDAR system for further processing.

The SPAD imager 110 may be included in other suitable systems and is not limited to the exemplary embodiments described herein. For example, a SPAD imager 110 configured to use an IAT-based determination of intensity may be included in other systems using light, for example visible light, near-infrared light, infrared light, or the like, to determine information about an environment in which the device is located.

Referring to FIG. 2, an exemplary SPAD device 202 includes a SPAD 204 having a cathode and an anode biased by power supply voltage terminals 208 and 210, respectively. During operation of the SPAD device 202, voltage terminals 208 and 210 may reverse bias SPAD 204 to a voltage higher than the breakdown voltage. When reversed biased above the breakdown voltage, absorption of a single photon by the SPAD 204 can cause a large avalanche current in the SPAD 204 due to impact ionization.

The avalanche process in the SPAD 204 can, and in some cases will, continue indefinitely. While the avalanche current continues, subsequent photons incident on the SPAD 204 cannot be detected. In some embodiments, the avalanche process is stopped using quenching circuitry 206, which may include passive or active quenching. Quenching circuitry 206 can be used to lower the bias voltage of the SPAD 204 below breakdown level. In some embodiments, passive quenching circuitry 206 may include a resistor in series between the SPAD 204 cathode and a positive bias voltage terminal 208 as shown in FIG. 2. A SPAD 204 coupled in series with a quenching resistor or other quench circuitry 206 may be referred to as a microcell or a SPAD pixel.

The avalanche current may produce an electrical signal that can be detected by readout circuitry 212. For example, initiation of the avalanche current due to detection of an incident photon by the microcell and subsequent quenching of the avalanche current may create a pulse current signal that the readout circuitry 212 can identify as a photon detection. The pulse current signal may be referred to herein as an avalanche pulse.

The readout circuitry 212 may process the detection of the current signal for a variety of purposes, for example counting the number of incident photons by counting the number of avalanche current pulses using analog or digital pulse counting circuits, and timing the laser time-of-flight (ToF) for determining a distance to the target, as discussed in more detail below. The example of FIG. 2 of the readout circuitry 212 coupled to a node between SPAD 204 and quenching circuitry 206 is merely illustrative. Readout circuitry 212 may be coupled to any suitable portion of the SPAD device 202. In some embodiments, the quenching circuitry 206 may be integrated with the readout circuitry 212.

A SPAD 204 must be quenched and reset for every initiated avalanche current. During the time required to quench and reset the SPAD 204, referred to as the dead time, no additional photons can be detected by the SPAD 204. The dead time therefore limits the number of photons detectable by the SPAD 204 for a given time period. In some embodiments, the dead time of a SPAD 204 may be on the order of nanoseconds, for example about 3 nanoseconds.

The SPAD 204 additionally has a chance of not generating an avalanche current in response to an incident photon. Accordingly, the SPAD 204 has a photon detection efficiency (PDE) that is a result of several factors, including a probability that a current carrier (electron and/or hole) is created when the SPAD 204 receives an incident photon, and a probability that the created current carrier initiates an avalanche current. For example, the SPAD 204 may have a PDE of about 30%, meaning the SPAD device 202 will detect about 30% of incident photons.

The SPAD imager 110 may include multiple SPAD devices 202 to increase the photon detection capability of the SPAD imager 110. In some embodiments, multiple SPAD devices 202 may be coupled in parallel (not shown) between the power supply voltage terminals 208 and 210 and may share a common readout circuitry 212. In some embodiments, each of the multiple SPAD devices 202 may have individual readout circuitry 212. In some embodiments, the SPAD devices 202 may be arranged as a one-dimensional or two-dimensional array, and the array may include tens, hundreds, thousands, tens of thousands (or more) SPAD devices 202.

In some embodiments, the SPAD imager 110 may be arranged as a two-dimensional array operable in a rolling-shutter and/or global shutter mode. In a global shutter mode, all SPAD devices 202 may be operated to detect photons in one time period. In a rolling shutter mode, individual rows or columns of SPAD devices 202 may be operated to detect photons in one time period. In some embodiments, each SPAD device 202 of the SPAD imager 110 may have its own readout circuitry 212. In some embodiments, each row and/or column of the SPAD imager 110 may have its own readout circuitry 212 that is shared by each SPAD device 202 in the row and/or column. In some embodiments, the SPAD imager 110 may have a readout circuitry 212 that is changeably coupled to the active row and/or column during a rolling shutter mode.

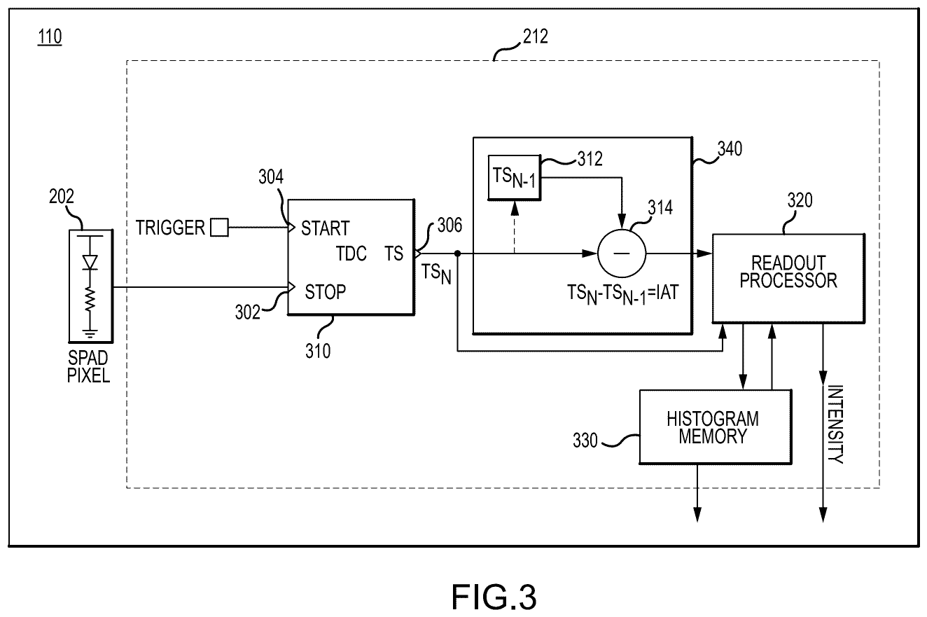

Referring to FIG. 3, an exemplary SPAD imager 110 may include readout circuitry 212 configured to determine an intensity of the target and/or a ToF of a detected reflected light 116. In some embodiments, the SPAD imager 110 and/or readout circuitry 212 may operate in multiple modes, including an intensity determination mode and a ToF mode. The SPAD imager 110 and/or readout circuitry 212 may be controlled, for example via the LiDAR module 102 or system 100, to alternatingly operate in the intensity determination mode and the ToF mode, to operate only in the intensity determination mode, and/or to operate only in the ToF mode. The intensity determination mode may be referred to herein as the intensity mode.

The SPAD imager 110 may include one or more readout circuits 212, and each readout circuitry 212 may be coupled with one or one or more SPAD devices 202. In the intensity mode, the readout circuitry 212 may be configured to determine an intensity of the target by analyzing the arrival time between successive photons, referred to herein as inter-arrival time (IAT), detected by the one or more SPAD devices 202. A detection of a photon by a SPAD device 202 may be referred to as a photon event. In the ToF mode, the readout circuitry 212 may be configured to determine a round-trip travel time of a laser photon, for example from a laser pulse, between the LiDAR module 102 and the target.

The readout circuitry 212 may include timestamp circuitry such as a time-to-digital converter (TDC) 310, IAT determination circuitry 340, averaging circuitry (not shown), and a readout processor 320. In some embodiments, the one or more SPAD devices 202 may be electrically coupled with one or more inputs of the TDC 310, and the TDC 310 output may be electrically coupled with an input of the IAT determination circuitry 340. The IAT determination circuitry 340 may be referred to herein as IAT circuitry. The output of the IAT circuitry 340 may be electrically coupled with the averaging circuitry. In some embodiments, the TDC 310 output may also or alternatively be directly coupled with the readout processor 320, for example to output timestamps directly to the readout processor 320 in ToF mode.

The averaging circuitry will be described herein as part of the readout processor 320, but it will be understood that the averaging circuitry may be implemented separately from the readout processor 320. More generally, in various embodiments, any combination of the TDC 310, IAT circuitry 340, and averaging circuitry may be implemented by the readout processor 320.

Some embodiments may include a hierarchy of readout circuitry 212 functions implemented at different levels of the SPAD imager 110, for example one TDC 310 per microcell or column with one IAT determination circuitry 340 and averaging circuitry per column and one readout processor 320 per SPAD imager, or the like. In some embodiments, each SPAD device 202 may be coupled with its own TDC 310 and IAT circuitry. In some embodiments, each SPAD device 202 is coupled with its own readout circuitry 212.

In some embodiments, the readout processor 320, TDC 310, IAT circuitry 340, and/or averaging circuitry may be implemented with a field-programmable gate array (FPGA). In some embodiments, the readout processor 320, TDC 310, IAT circuitry 340, and/or averaging circuitry may be implemented on the same semiconductor substrate as the SPAD devices 202. In some embodiments, the readout processor 320, TDC 310, IAT circuitry 340, and/or averaging circuitry may be implemented on a separate semiconductor substrate, for example in a stacked chip configuration.

Still referring to FIG. 3, the TDC 310 may receive the avalanche pulse signals generated by the one or more SPAD devices 202 in response to photon detection by the connected SPAD device(s) 202. The TDC 310 may include any suitable system and/or method for determining a relative or absolute time that each avalanche pulse is received by the TDC 310 with respect to a start signal or other trigger. In some embodiments, the SPAD device(s) 202 may be electrically coupled with a first input 302 of the TDC 310, and the start signal or trigger may be electrically coupled with a second input 304 of the TDC 310. The first input 302 may be referred to as the STOP input, and the second input 304 may be referred to as the START input.

The TDC 310 may output, for example on a first output 306, an indication of the determined relative or absolute time. The indication of time provided by the TDC 310 on the first output 306 in response to a received avalanche pulse may be referred to herein as the timestamp (TS) of the detected photon. The first output 306 may be referred to herein as the TS output.

In some embodiments, the TDC 310 may start incrementing a counter or timer when it receives a start signal or other trigger on the START input 304, and subsequently in response to receiving an avalanche pulse signal on the STOP input 302 may output, via the TS output 306, the elapsed time (the timestamp) since the received start signal. The elapsed time may be output by the TDC 310 as the current count of the counter, the current time of the timer, or any other suitable indication of elapsed time since the start signal was received. It will be understood that the TDC 310 may be implemented in other suitable configurations in accordance with the various embodiments.

As described above, the SPAD imager 110 may be operated in an intensity mode to determine an intensity of the target. During the intensity mode, the SPAD imager 110 may operate to detect multiple incident photons over an amount of time referred to as the integration period or integration time. In some embodiments, the multiple incident photons may be ambient photons reflected off the target and/or reflected photons 116 from the laser 104. In some such embodiments, the multiple incident photons may be primarily or exclusively ambient photons received from the environment in which the SPAD imager 110 is operating.

In some embodiments, the SPAD imager 110 may be operated in intensity mode alternatingly or otherwise in between ToF mode operations, such that the laser 104 is not operated during intensity mode. The intensity mode may be performed in between the laser pulses of the ToF mode. For example, at a scan point of the LiDAR module 102, the SPAD imager 110 may be operated in intensity mode in between laser pulses of a ToF measurement. In some embodiments, a determination may be made whether to perform the intensity measurement and/or the integration period based on the time of flight from prior ToF measurement(s).

In some cases, the ambient photons may be solar photons, may be photons generated from other light sources, or photons from any other source of photons independent from the laser 104. In some embodiments, depending on the specific arrangement of the SPAD imager 110, LiDAR module 102, system 100, operating environment, and the like, the number of ambient photons received by the SPAD imager 110 from the environment may be significantly larger, for example by five to ten orders of magnitude, than the number of detectable photons from the laser 104.

While the SPAD imager 110 is operating in the intensity determination mode, the TDC 310 may continue to receive avalanche pulses from the SPAD device(s) 202 during the integration period. The SPAD imager 110 may determine the timing of the multiple incident photons in relation to each other. In some embodiments, during the integration period of the intensity mode, the TDC 310 may continue to output timing information on the TS output 306 in response to each received avalanche pulse signal on the STOP input 302 without resetting, stopping, or restarting the counter or timer of the TDC 310. In some such embodiments, the timestamp output on the TS output 306 continues to increase for each subsequent photon event. The TDC 310 may output timestamps TS₁ . . . TS_{N} for photons 1 . . . N detected during the integration period, respectively.

In some embodiments, during the intensity determination mode, the first avalanche pulse signal may be provided to one of the inputs 302, 304 of the TDC 310 to start the timer, counter, or the like of the TDC 310. The first avalanche pulse signal may represent the first detected photon by the SPAD device(s) 202 coupled with the TDC 310 during the integration period, and the TDC 310 may be configured to output an initial timestamp, for example representing a time or count of zero, in response to receiving the first avalanche pulse signal. In some such embodiments, the SPAD imager 110 may be configured to provide the first avalanche pulse to the START input 304 of the TDC 310, and the TDC 310 may be configured to output the initial timestamp in response to receiving the first avalanche pulse signal on the START input 304. In other such embodiments, the TDC 310 may output the initial timestamp in response to receiving the first avalanche pulse signal on the STOP input 302.

In some embodiments, during the intensity determination mode, the TDC 310 may be started based on a control signal, for example received on the START input 304, other than receiving the first avalanche pulse. In some such embodiments, the TDC 310 may output the first timestamp TS₁ in response to receiving the first avalanche signal pulse on the STOP input 302 sometime after the TDC 310 was started. In some embodiments, the laser 104 may continue to operate during the intensity mode and may send a trigger control signal to the START input 304 of the TDC 310 upon activation.

In some embodiments, the integration period may be predetermined, may be reactive to the lighting conditions in which the SPAD imager 110 is operating and/or may otherwise be suitably selected to detect a desired dynamic range of intensity. The lighting conditions may, in some embodiments, include the incident photon rate for ambient photons. As discussed above, typical outdoor, sunlit conditions may receive about 10⁵ to about 10¹⁰ ambient photons per second.

The integration period may also depend on other parameters, such as the field of view of the LiDAR module 102, the configuration of the optics and beam steering module 106, the PDE of the SPAD 204, the dead time of the SPAD device 202, a temporal resolution of the TDC 310, and the like. In some exemplary embodiments, the integration period may be on the order of microseconds or milliseconds, for example from about one twentieth to about one half of a millisecond for a PDE of 30%, dead time of 3 ns, and TDC resolution of 125.0 picoseconds. In some exemplary embodiments, the integration period may be about 0.125 milliseconds.

The SPAD imager 110 may determine one or more IATs based on the timestamps of the TDC 310 during the integration period. IAT determination may be performed, for example, by the TDC 310, by the readout processor 320, by IAT determination circuitry 340, or the like.

For example, still referring to FIG. 3, the IAT determination circuitry 340 may include any suitable system and/or method configured to determine the IAT between successive photon events. In some embodiments, the IAT determination circuitry 340 may include a timestamp memory 312 and a subtraction circuit 314. The timestamp memory 312 may be configured to store the prior timestamp TS_{N-1}, that is, the TS last output by the TDC 310 before the current timestamp TS_{N} in response to the respective photon detections. The subtraction circuit 314 may be configured to subtract the prior timestamp TS_{N-1} from the current timestamp TS_{N} to obtain the IAT between the prior and current photon detections.

The timestamp memory 312 may be any suitable system or method for storing a TS output by the TDC 310, for example one or more registers or latches, a static or dynamic memory, or the like. The timestamp memory 312 may be a single memory location configured to store the prior timestamp and to be overwritten with subsequent timestamps as they are received from the TDC 310. The subtraction circuit 314 may be any suitable system or method for subtracting one TS from another TS, for example a binary subtraction circuit. The IAT output of the subtraction circuit 314 may comprise the difference in counter value between the prior and current TS, may comprise the difference in time between the prior and current TS, or the like.

The readout processor 320 may include any suitable systems and/or methods for determining information about the sensed environment based on the output of the TDC 310, IAT determination circuitry 340, and/or the like. For example, in some embodiments, the readout processor 320 may include ToF circuitry to determine a distance to the target based on the direct output 306 of the TDC 310 in a ToF mode. The readout processor 320 may write to and read from a histogram memory 330 to determine the distance based a set of timestamps taken during ToF mode.

More specifically, in ToF mode, the LiDAR module 102 may use multiple laser pulses to create a histogram in the histogram memory 330 based on the timestamps generated by the TDC 310 in response to the detection of each laser pulse. The readout processor 320 may increment addresses in the histogram memory 330 based on the timestamps from the TDC 310 while laser pulses are being sent and received. The histogram will include information from actual detections of the returned laser pulses along with ambient photons that triggered an avalanche pulse, which represent noise.

The readout processor 320 may read the completed histogram information from the histogram memory 330 to determine the peak of the histogram. The peak of the histogram should represent detections of reflected laser light. The peak of the histogram may be determined based on the histogram memory 330 location having the largest value, and can therefore be used to estimate the time taken for a laser pulse to travel to the target and to be reflected 116 back to the SPAD imager 110. The determined time can then be converted to a distance measurement by the readout processor 320, the system processor 112, or the like.

In some embodiments, the readout processor 320 may include the averaging circuitry, and may implement statistical methods. The averaging circuitry may be configured, in the intensity mode, to perform a statistical analysis of a plurality of IATs received from the IAT circuitry in response to photons detected during the integration period. The statistical analysis may include any suitable analysis for determining information about the intensity of the target based on the plurality of IATs for the integration period. In some embodiments, the statistical analysis may include determining an arithmetic mean of the plurality of IATs, a median of the plurality of IATs, or the like.

The averaging circuitry and/or readout processor 320, as desired, may convert the statistical analysis to an indication of the intensity of the target usable by the system 100. In some embodiments, determining the indication of intensity includes calculating the reciprocal of the mean or median of the plurality of IATs. For example, the mean of the plurality of IATs represents the average time between successive photon detections during the integration period such that the shorter the time between successive photons, the more photons were received from the target (or FoV as appropriate). The reciprocal of the mean therefore increases as more photons are detected, such that the indication of intensity increases as more photons are detected.

The indication of intensity may be used by the SPAD imager 110, LiDAR module 102, system processor 112, system 100, or by any other suitable system or method, to determine an intensity of the target and/or other objects in the FoV for any suitable purpose. In some embodiments, the indication of intensity may be used, whether directly or after appropriate scaling, to create a grayscale image by determining pixel values based on the indication of intensity. In some embodiments, the SPAD imager 110 may include a color filter array, for example in a Bayer pattern, and the indication of intensity may be used to create a color image. In some embodiments, a lookup table may be used to determine or otherwise estimate a photon count based on the indication of intensity, and the photon count may then be used for any suitable purpose.

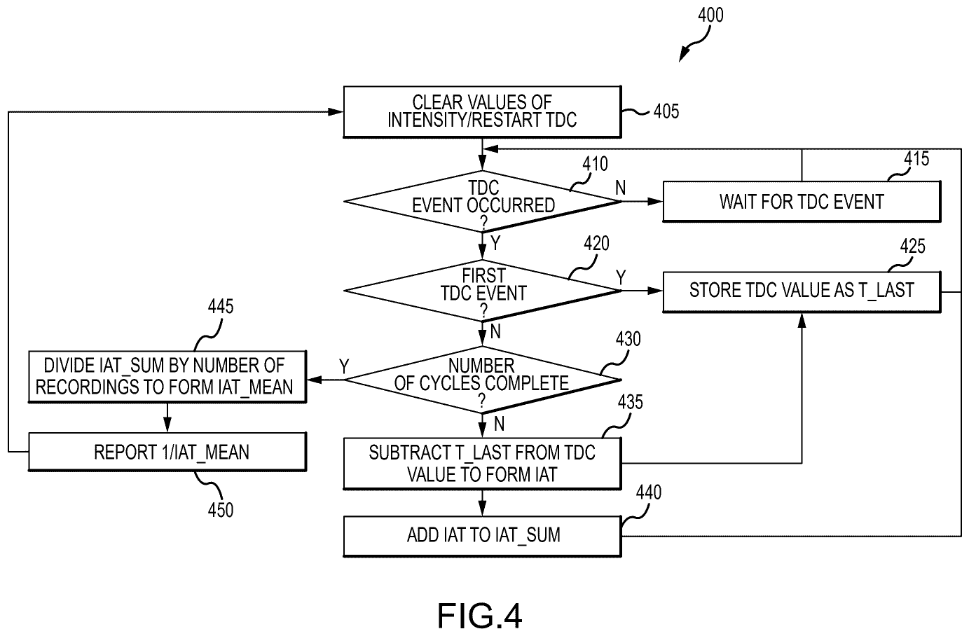

FIG. 4 illustrates an intensity determination method 400 of operating a SPAD imager 110 to determine an IAT-based intensity, for example according to the SPAD imager 110 illustrated in FIG. 3. Step 405 includes initialization processes that may be performed prior to or at the initiation of the integration period, or otherwise prior to photon events during the integration period. Step 405 may include, for example, resetting values from a prior iteration of the intensity determination method 400, such as the value of the indication of intensity, IAT statistics such as a calculated mean, an IAT sum, a count of IATs, or the like. Step 405 may also include restarting the TDC 310, for example sending a control signal to the START input 304 of the TDC 310.

At step 410, the SPAD imager 110 may check if a photon event has occurred, which may be indicated by the TDC 310 outputting a timestamp. If no photon event has occurred, then the SPAD imager 110 will continue to wait for the first photon event at step 415.

At step 420, in response to determining at step 410 that a photon event has occurred, the SPAD imager 110 may determine if the photon event is the first photon event, TS₁, during the integration period. In some embodiments, the SPAD imager 110 may use the IAT circuitry 340, a hardware or software flag, or the like, to make the determination 420. Because each inter-arrival time may require two timestamps to determine the time difference between the timestamps, determining the first IAT may require storing the timestamp TS₁ corresponding to the first photon event while awaiting the second photon event.

At step 425, if the photon event is determined 420 to be the first photon event, then the first timestamp value TS₁ may be stored so that the first IAT may be calculated upon receiving the second photon event. The first timestamp value may be stored as the value to be subtracted for determining an IAT. In some embodiments, at step 425, the first timestamp value TS₁ may be stored in the timestamp memory 312 as the prior timestamp to later be subtracted from the next timestamp TS₂ by the subtraction circuit. In some embodiments, after storing 425 the first timestamp value, the intensity determination method 400 may continue to wait for the next photon event at steps 410 and 415.

At step 430, for subsequent photon events after the first photon event, a check may be performed to determine if the integration period or other period for measuring IAT values is finished. In some embodiments, the check may include determining if a certain number of cycles of a clock of the SPAD imager 110 have been completed, if a certain amount of time such as the integration time has elapsed, or the like.

At step 435, if the integration period is determined 430 to not be complete, then the last timestamp TS_{N-1} may be subtracted from the current timestamp TS_{N} to determine the current IAT. In some embodiments, the subtraction circuitry 314 may subtract the current timestamp received from the TDC 310 from the prior timestamp stored in the timestamp memory 312 to determine the current IAT. After performing the subtraction 435, the current timestamp may be stored as the prior timestamp according to step 425, for example by the IAT circuitry 340.

The current IAT may be provided to the averaging circuitry. At step 440, the averaging circuitry may collect the multiple IATs provided by the IAT circuitry 340 to perform a statistical analysis. In some embodiments, at step 440, each received IAT added to an IAT sum, and each received IAT increments a count of received IAT's by one. Therefore, after each step 440, the IAT sum represents the sum of all IATs received at that time and the count represents the number of received IATs at that time. After adding the current IAT to the IAT sum and respectively increasing the IAT count, the intensity determination method may continue to wait for the next photon event at steps 410 and 415.

If the integration period is determined 430 to be complete, then the averaging circuitry may perform the statistical analysis at step 445. In some embodiments, the averaging circuitry may divide the IAT sum by the IAT count to determine a mean of the IAT values received during the integration period. In some alternative embodiments, the averaging circuitry may perform the statistical analysis after each received IAT, for example calculating an updated IAT mean after each received IAT.

At step 450, the SPAD imager 110, for example by the averaging circuitry and/or readout processor 320, may report an indication of the intensity based on the statistical analysis of step 445. In some embodiments, at step 450, the reciprocal of the determined mean of the IAT values may be reported as the indication of the intensity. In some embodiments, after step 450, the intensity determination method 400 may then return to step 405 to prepare for a next integration period for determining a next indication of intensity, for example for a next scan point of the LiDAR module 102.

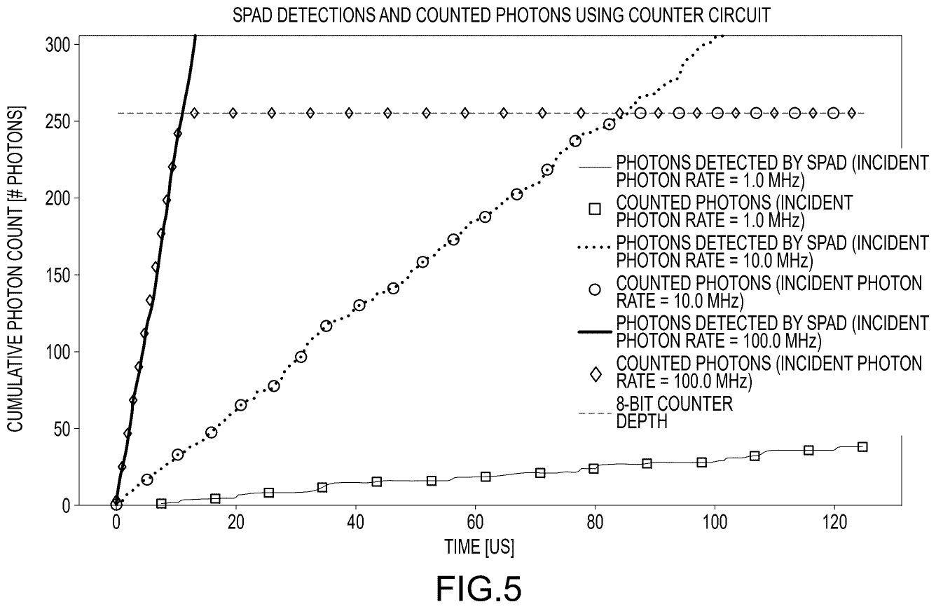

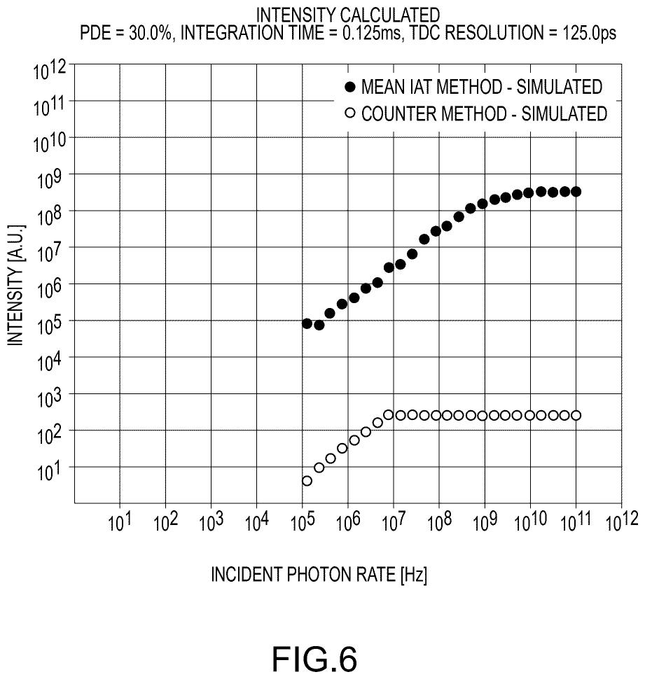

FIGS. 5 and 6 show simulation results for different methods of determining intensity of a target using a SPAD imager 110. Referring to FIG. 5, a graph of counted photon events is shown for a counter-based system and method of determining the intensity of a target, for various incident photon rates. A SPAD pixel having an 8-bit counter, a PDE of 30%, and a dead time of 3 nanoseconds was simulated with incident photon rates of 1.0 MHz, 10.0 MHz, and 100.0 MHz. The 8-bit counter will saturate, in other words will not be able to continue counting photons, after it reaches a value of 255.

For a 1.0 MHz incident photon rate (10⁶ photons per second), the 8-bit counter remains unsaturated after a 125-microsecond integration period. For a 10.0 MHz incident photon rate (10⁷ photons per second), the 8-bit counter saturates after about 85 microseconds, and therefore does not accurately indicate the number of received photons during the integration period. For a 100 MHz incident photon rate (108 photons per second), the 8-bit counter saturates after about 10 microseconds, severely undercounting the number of received photons during the integration period. When the counter saturates before the end of the integration period, the intensity of the target cannot be accurately determined due to the loss of information. In other words, the dynamic range of the counter-based system is not sufficient.

Referring to FIG. 6, a graph of indicated intensity for both the counter method and the IAT method are shown for various incident photon rates. A SPAD pixel having a PDE of 30% was simulated with an 8-bit counter, and the same SPAD pixel was also simulated with readout circuitry performing the mean IAT method, both for a 125-microsecond integration period and a TDC resolution of 125.0 picoseconds. As seen with respect to FIG. 5, the counter method for determining intensity fails to accurately indicate intensity for an incident photon rate at or above about 10⁷ incident photons per second.

In contrast, the mean IAT system and method for determining intensity accurately represents the target intensity from at least about 10⁵ to about 10¹⁰ incident photons per second, with the reported intensity increasing approximately linearly with incident photon rate. This linearity allows an accurate conversion back to incident photon rate, and a corresponding intensity of the target. The dynamic range of the IAT-based system and method is therefore improved.

For the simulated mean IAT system, photon rates above about 10¹⁰ photons per second resulted in inter-arrival times sufficiently low to be limited by the TDC resolution. The upper and lower limit of accurately reportable intensity may therefore be adjusted by adjusting SPAD imager parameters, such as integration period, TDC resolution, PDE, and the like. The IAT-based systems methods therefore allow for increased range, flexibility, and accuracy for determining target intensity without requiring additional chip area, as compared to the counter-based systems and methods of determining intensity.

Various embodiments therefore provide SPAD-based systems, devices, and methods that can determine information about an intensity of a target in a field of view using inter-arrival time information. Various embodiments may determine intensity information using a timestamp memory location and a subtraction circuit to determine IATs, and an analysis of the IATs (for example, determining the IAT mean) may be performed to determine intensity information.

In contrast to prior methods of determining intensity information using hardware counters that may easily saturate, systems and methods as described herein permit a more accurate measurement of intensity information over a larger range of lighting conditions. Various embodiments advantageously require less chip area and have an increased dynamic range compared to counter-based systems and methods, and are easily tunable for various applications such as LiDAR systems operating in a variety of conditions. Other embodiments may provide additional benefits and features, as desired.

The various functions shown and described in the process flows and SPAD imager may be distributed amongst the various components of system 100 in any manner, and different embodiments may organize the processing of various features and information in any number of different ways. Each of the various features and systems described herein may be implemented in software and/or firmware that resides in non-transitory data storage for execution by one or more processors to perform the various automated processes described herein.

It will be recognized that circuitry described herein may alternatively or additionally be implemented as computer instructions (software, firmware, or the like) configured to cause a processor to perform the functions of the described circuitry. It will also be recognized that computer instructions described herein may alternatively or additionally be implemented as hardware circuitry operable to perform the functions of the described computer instructions.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A device for determining an intensity of a target, comprising:
one or more single photon avalanche diodes (SPADs);
a timestamp circuitry coupled to the one or more SPADs and configured to output a timestamp in response to receiving an avalanche pulse from the one or more SPADs;
an inter-arrival time (IAT) circuitry coupled to the timestamp circuitry, wherein the IAT circuitry is configured to determine a time difference between successive photons detected by the one or more SPADs based on successive timestamps received from the timestamp circuitry; and
an averaging circuitry coupled with the IAT circuitry, wherein the averaging circuitry is configured to perform a statistical analysis of a plurality of determined time differences from the IAT circuitry to determine an indication of the intensity of the target.

2. The device of claim 1, further comprising a readout processor coupled to the IAT circuitry, wherein:
the timestamp circuitry comprises a time-to-digital (TDC) converter; and
the readout processor implements the averaging circuitry.

3. The device of claim 1, wherein the IAT circuitry comprises:
a timestamp memory operable to store a prior timestamp from the timestamp circuitry; and
a subtraction circuit coupled with the timestamp memory and operable to subtract the prior timestamp from a current timestamp received from the timestamp circuitry.

4. The device of claim 1, wherein the statistical analysis of the averaging circuitry comprises determining a mean of the plurality of determined time differences.

5. The device of claim 4, wherein the indication of the intensity of the target comprises a reciprocal of the determined mean.

6. The device of claim 1, wherein the device comprises a SPAD imager, and wherein:
the SPAD imager is configured to operate in an intensity mode and a time-of-flight (ToF) mode;
the SPAD imager is operable, in the intensity mode, to:
determine the plurality of time differences during an integration period; and
determine the indication of the intensity of the target; and
the SPAD imager is operable, in the ToF mode, to determine a distance to the target.

7. The device of claim 6, wherein the SPAD imager is operable to alternate between the intensity mode and the ToF mode.

8. A method of operating a single photon avalanche diode (SPAD) device, the method comprising:
receiving, from a timestamp circuitry of the SPAD device, a plurality of successive timestamps in response to a plurality of successive photons detected by the SPAD device;
determining, by an inter-arrival time (IAT) circuitry and based on the plurality of successive timestamps, a plurality of inter-arrival times, wherein each inter-arrival time represents a time difference between photons successively detected by the SPAD device;
performing, using an averaging circuitry, a statistical analysis of the plurality of inter-arrival times; and
determining an indication of an intensity of a target of the SPAD device based on the statistical analysis.

9. The method of claim 8, wherein the statistical analysis comprises determining a mean of the plurality of inter-arrival times.

10. The method of claim 9, wherein determining the indication of the intensity comprises determining a reciprocal of the determined mean.

11. The method of claim 8, wherein performing the statistical analysis using the averaging circuitry comprises performing the statistical analysis using a readout processor of the SPAD device.

12. The method of claim 8, further comprising alternatingly operating the SPAD device in an intensity mode and a time-of-flight (ToF) mode, wherein:
the intensity mode comprises performing the steps of receiving the plurality of successive timestamps, determining the plurality of inter-arrival times, performing the statistical analysis, and determining the indication of the intensity; and
the ToF mode comprises determining, based on a timestamp from the timestamp circuitry, a distance to the target.

13. The method of claim 8, wherein determining each of the plurality of inter-arrival times comprises:
storing, using a timestamp memory, a prior timestamp from the timestamp circuitry; and
subtracting, using a subtraction circuitry, the prior timestamp from a current timestamp received from the timestamp circuitry.

14. The method of claim 8, wherein the plurality of successive timestamps are received during an integration period.

15. A light detection and ranging system, comprising:
a laser;
a single photon avalanche diode (SPAD) imager configured to, in an intensity mode:
measure a plurality of inter-arrival times (IAT), wherein each IAT represents a time difference between successive photons detected by the SPAD imager;
perform a statistical analysis of the plurality of IATs; and
determine an indicator of an intensity of a target based on the statistical analysis; and
an optical device operable to direct a laser pulse from the laser toward the target and to direct one or more photons from the target to the SPAD imager.

16. The light detection and ranging system of claim 15, wherein the statistical analysis comprises determining a mean of the plurality of IATs.

17. The light detection and ranging system of claim 16, wherein determining the indicator of the intensity comprises determining a reciprocal of the determined mean.

18. The light detection and ranging system of claim 15, wherein the SPAD imager is further configured to, in a time-of-flight (ToF) mode:
determine a timestamp for a detection of the one or more photons directed to the SPAD imager by the optical device; and
determine a distance to the target based on the determined timestamp.

19. The light detection and ranging system of claim 18, wherein the SPAD imager is further configured to alternatingly operate in the ToF mode and the intensity mode.

20. The light detection and ranging system of claim 15, wherein the SPAD imager is configured to measure the plurality of IATs during an integration period in the intensity mode.
